(19) United States
(12) Patent Application Publication
(10) Pub. No.: US 2008/0316455 A1
(43) Pub. Date: Dec. 25, 2008

(54) PROJECTION OBJECTIVE OF A MICROLITHOGRAPHIC PROJECTION EXPOSURE APPARATUS

(75) Inventors: Dirk Hellweg, Aalen (DE); Heiko Feldmann, Aalen (DE)

Correspondence Address: FISH & RICHARDSON PC, P.O. BOX 1022, MINNEAPOLIS, MN, 55440-1022, US

(73) Assignee: Carl Zeiss SMT AG, Oberkochen (DE)

(21) Appl. No.: 12/180,218

(22) Filed: Jul. 25, 2008

Related U.S. Application Data
(63) Continuation of application No. PCT/EP2007/051497, filed on Feb. 16, 2007.

(30) Foreign Application Priority Data
Mar. 8, 2006 (DE) 10 2006 011 098.6

(51) Int. Cl. G03B 27/54; G02B 9/00

(52) U.S. Cl. 355/67; 359/796

(57) ABSTRACT

The disclosure relates a projection objective of a microlithographic projection exposure apparatus. In some embodiments, the apparatus is configured to project a mask which can positioned in an object plane onto a light-sensitive layer which can be positioned in an image plane. The projection objective can include a last optical element at the image plane side having a light entrance surface and a light exit surface. The projection objective can also include an immersion liquid is arranged in a region between the light exit surface and the image plane. At a working wavelength of the projection objective, the immersion liquid can have a refractive index of at least 1.5. At least one interface between the light entrance surface of the last optical element at the image plane side and the immersion liquid can have at least region-wise a microstructuring.

### CROSS-REFERENCE TO RELATED APPLICATIONS

This application is a continuation under 35 U.S.C. §120 of international application serial number PCT/EP2007/051497, filed Feb. 16, 2007, which claims the benefit of German patent application serial number 10 2006 011 098.6, filed Mar. 8, 2006. The contents of international application serial number PCT/EP2007/051497 are hereby incorporated by reference in their entirety.

### FIELD

The disclosure relates a projection objective of a microlithographic projection exposure apparatus.

### BACKGROUND

Microlithography is used for the production of microstructured components such as for example integrated circuits or LCDs. The microlithography process is carried out in what is referred to as a projection exposure apparatus which has an illumination system and a projection objective. The image of a mask (commonly referred to as a reticle) illuminated via the illumination system is projected via the projection objective onto a substrate (for example a silicon wafer) which is coated with a light-sensitive layer (for example photoresist) and arranged in the image plane of the projection objective in order to transfer the mask structure onto the light-sensitive coating on the substrate.

In immersion lithography, an immersion medium having a refractive index of greater than one can be disposed between the last optical element of the projection objective, at the image plane side, and the light-sensitive layer. In some instances, the immersion medium is deionized water, which has a refractive index at a wavelength of λ=193 nm of about n=1.43.

### SUMMARY

In some embodiments, the disclosure provides a projection objective of a microlithographic projection exposure apparatus, which, even when using highly refractive immersion media, can permit beam coupling at high numerical apertures to achieve higher levels of resolution.

In certain embodiments, the disclosure provides a projection objective of a microlithographic projection exposure apparatus, for projecting a mask which can positioned in an object plane onto a light-sensitive layer which can be positioned in an image plane. The projection objective has a last optical element at the image plane side having a light entrance surface and a light exit surface. The projection objective also includes an immersion liquid arranged in a region between the light exit surface and the image plane. At a working wavelength of the projection objective the immersion liquid has a refractive index of at least 1.5. At least one interface between the light entrance surface of the last optical element at the image plane side and the immersion liquid has at least region-wise a microstructuring.

The term “microstructuring” is used in the context of the present application to denote a diffractive structure which provides an additional “diffractive” refraction power in the projection objective. Such a diffractive structure can be produced by, for example, electron-lithographic processes.

As a consequence of the microstructuring, a refraction power can be introduced in the projection objective in the region after the light entrance surface of the last optical element at the image plane side and before the immersion liquid, which can help facilitate beam coupling into the immersion liquid. In some instances, the microstructuring can permit the same at higher aperture angles without curvature of the immersion liquid at the light entrance side. This can be advantageous in regard to the immersion liquid flow, which occurs in the immersion mode, between the projection objective and the wafer. In some cases, the light exit surface of the last optical element at the image plane side can be substantially flat (that is to say except for a microstructuring according to the disclosure which is possibly provided there) and/or the interface of the immersion liquid, at the light entrance side, can be substantially flat. Furthermore coupling into the immersion liquid can be achieved at high aperture angles without the use of highly refractive materials (with a refractive index greater than the refractive index of quartz which at 193 nm is about n=1.56) so that problems in that respect (for example in regard to the availability of such materials with adequate transmission properties and of sufficient optical quality) can be avoided.

In some embodiments, the light entrance surface of the last optical element at the image plane side itself is not embraced by the criterion that the interface having the microstructuring is disposed “between the light entrance surface of the last optical element at the image plane side and the immersion liquid”, that is to say the interface is arranged downstream of that light entrance surface in the light propagation direction.

In some embodiments, at a working wavelength of the projection objective the immersion liquid can have a refractive index of at least 1.6.

In certain embodiments, the microstructuring is provided on the light exit surface of the last optical element at the image plane side.

In some embodiments, the last optical element at the image plane side has at the light exit side at least one layer. At a working wavelength of the projection objective that layer can have in particular a refractive index greater than the refractive index of a material from which the last optical element at the image plane side is produced.

In certain embodiments, that layer covers the at least one microstructuring. By such a layer, on the one hand the microstructuring can be protected while on the other hand it is also possible to avoid a surface roughness introduced by the microstructuring occurring at the interface in relation to the immersion liquid, thereby also achieving improved wetting of that interface with immersion liquid.

In some embodiments, the at least one microstructuring can be provided in a light exit surface of the layer. That can have the advantage that it is possible to dispense with microstructuring of the material of the last optical element at the image plane side (for example quartz or calcium fluoride).

Such a microstructuring in the light exit surface of the layer can also in turn be covered by a further layer, whereby once again it is possible to provide a protective action for the microstructuring and an interface, which can be better wetted, towards the immersion liquid. That further layer can in particular have a refractive index which is substantially coincident with the refractive index of the immersion liquid so that no further beam deflection occurs at the transition to the immersion liquid.

In certain embodiments, the last optical element at the image plane side is formed from a first subelement and a second subelement. The at least one microstructuring is arranged at an interface between the first subelement and the second subelement. The first subelement and the second subelement can be seamlessly joined together, such as, for example, via wringing. In some embodiments, the first subelement can be a planoconvex lens and the second subelement can be a planoparallel plate. Such a planoparallel plate can make it possible to produce a sufficiently large spacing for the diffractive optical structure formed by the microstructuring from the image plane.

Optionally, the second subelement is formed from a material which at a working wavelength of the projection objective has a refractive index greater than that of quartz (SiO₂). In some embodiments, the refractive index of that material at a working wavelength of the projection objective is at least 1.7 (e.g., at least 1.85, at least 2.0). The second subelement can be formed in particular from a material selected from lutetium aluminum garnet (Lu₃Al₅O₁₂), spinel (MgAl₂O₄), yttrium aluminum garnet (Y₃Al₅O₁₂), NaCl, ZrO₂:0.12 Y₂O₃, Al₂O₃ and Y₂O₃.

In certain embodiments, the at least one microstructuring has a diffractive grating structure with a grating constant in the range of between 200 L/mm and 3000 L/mm, where L/mm represents lines per millimeter.

In some embodiments, a blazed diffractive optical structure is formed by the at least one microstructuring. In that respect the expression a blazed diffractive optical structure is used to denote a structure for setting a high level of diffraction efficiency in a given diffraction order, wherein the diffraction efficiency is correspondingly low for the other diffraction orders, that is to say the energy is maximized in a desired diffraction order. Such a blazed diffractive optical structure can be in the form of an index grating or in the form of a surface profile in basically known fashion.

In certain embodiments, a quantized diffractive optical structure is formed by the microstructuring. Such a quantized diffractive optical structure can be formed in basically known manner as a binary grating, that is to say an amplitude or phase grating, or a multi-phase level structure.

Further configurations of the disclosure are set forth in the description and the appendant claims.

The disclosure is described in greater detail hereinafter via embodiments by way of example illustrated in the accompanying drawings.

### BRIEF DESCRIPTION OF THE DRAWINGS

In the drawings:

FIG. 1 shows a diagrammatic view of the structure in principle of a microlithographic projection exposure apparatus with an illumination system and a projection objective;

FIG. 2 shows a diagrammatic sectional view of a detail of the projection objective of FIG. 1 with a microstructuring;

FIG. 3 shows a diagrammatic sectional view to describe the implementation of a microstructuring; and

FIG. 4 shows diagrammatic views to describe the implementation of a microstructuring.

### DETAILED DESCRIPTION

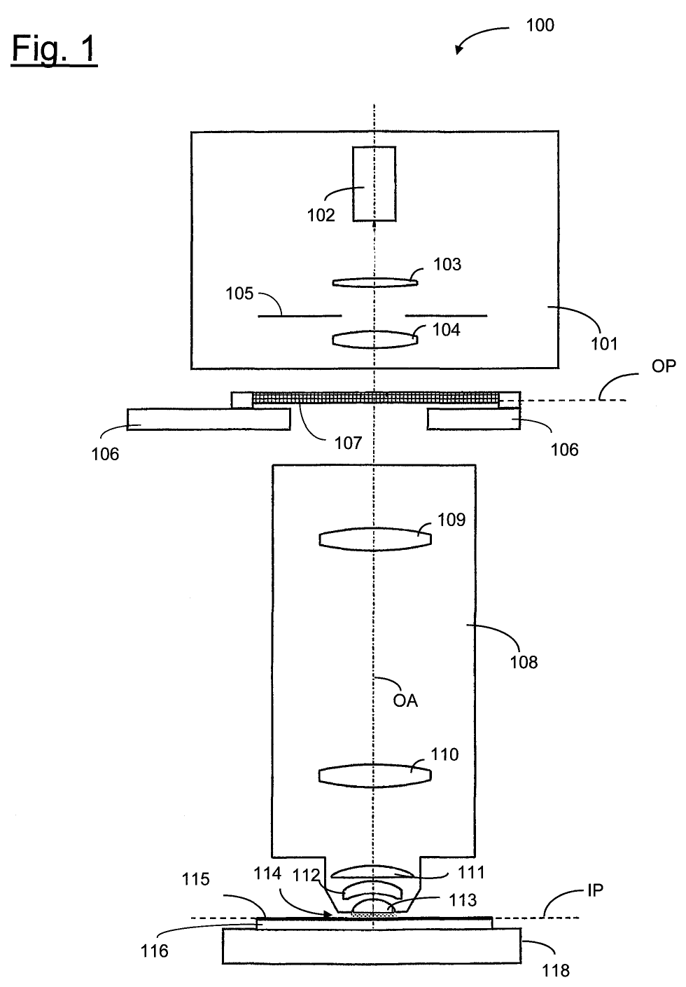

FIG. 1 shows a diagrammatic view illustrating the structure in principle of a microlithographic projection exposure apparatus 100. The projection exposure apparatus 100 has an illumination system 101 and a projection objective 108.

The illumination system 101 includes a light source 102 and an optical illumination arrangement symbolically represented in greatly simplified fashion by lenses 103, 104 and an aperture member 105. The working wavelength of the projection exposure apparatus 100 in the illustrated example is 193 nm when using an ArF-excimer laser as the light source 102. The working wavelength however can also be for example 248 nm when using a KrF-excimer laser or 157 nm when using an F₂-laser as the light source 102.

Arranged between the illumination system 101 and the projection objective 108 is a mask 107 disposed in the object plane OP of the projection objective 108 and held in the beam path by a mask holder 106. The mask 107 has a structure in the micrometer to nanometer range, the image thereof being produced onto an image plane IP of the projection objective 108 on a reduced scale for example by the factor of 4 or 5 by the projection objective 108.

The projection objective 108 includes a lens arrangement which is also only symbolically represented in greatly simplified fashion by lenses 109 through 113 and which defines an optical axis OA.

A substrate 116, or a wafer, which is positioned by a substrate holder 118 and which is provided with a light-sensitive layer 115 is held in the image plane IP of the projection objective 108. The minimum structures which can still be resolved generally depend on the working wavelength λ of the projection exposure apparatus 100 and the image-side numerical aperture of the projection objective 108. The maximum achievable resolution generally increases with decreasing working wavelength λ of the illumination system 101 and with an increasing image-side numerical aperture of the projection objective 108.

Disposed between the last optical element 113 of the projection objective 108, at the image plane side, and the light-sensitive layer 115 is an immersion liquid 114 whose refractive index in the illustrated example is greater than that of deionized water at the working wavelength (for example λ=193 nm) and in the example is n=1.65 at a wavelength of λ=193 nm. A liquid which is suitable for example for that purpose is identified by the designation “Dekalin”.

The disclosure is not restricted to use in a specific objective design and can be employed both in catadioptric and also in purely refractive projection objectives. Examples of suitable objective designs are to be found inter alia in above-quoted WO 2005/081067 A1, the contents of which are hereby incorporated by reference in their entirety.

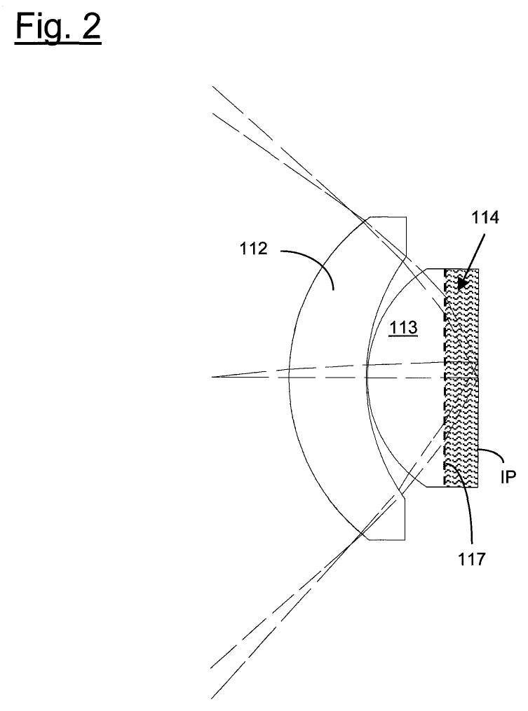

An interface disposed between the light entrance surface of the last optical element 113 at the image plane side and the immersion liquid 114 has at least region-wise a microstructuring. In the example shown in FIG. 1 that microstructuring is arranged on the light exit surface of the last optical element 113 at the image plane side and directly at the transition to the immersion liquid 114, as will be described in greater detail hereinafter with reference to FIG. 2.

FIG. 2 shows a diagrammatic sectional view of a detail of the projection objective 108, in which respect it is possible to see the position of a microstructuring 117 at the interface between the last optical element 113 at the image plane side and the immersion liquid 114. The microstructuring 117 can be in the form of a CGH (=“computer generated hologram”) on the light exit surface of the last optical element 113 at the image plane side.

The design data of the arrangement shown in FIG. 2 are set forth in Table 1. Therein the number of the respective refracting or otherwise significant optical surface is specified in column 1, the radius r of that surface (in mm) is specified in column 2, the spacing, identified as thickness, of that surface relative to the subsequent surface (in mm) is specified in column 3, the optically usable free diameter of the optical component is specified in column 4, the material following the respective surface is specified in column 5 and the refractive index of that material at λ=193 nm is specified in column 6.

TABLE 1

| Surface | Radius | Thickness | Diameter | Material | n |
|---|---|---|---|---|---|
| 1 | 180.000 | 70.000 | 282.45 | SiO₂ | 1.56 |
| 2 | 183.673 | 1.000 | 217.84 | | |
| 3 | 115.863 | 70.000 | 190.00 | SiO₂ | 1.56 |
| 4 | flat | 30.000 | 144.97 | Dekalin | 1.65 |
| (diffractive | | | | | |
| optical | | | | | |
| structure) | | | | | |
| Image field | flat | | 28.0 | | |

The diffractive optical structure formed by the microstructuring 117 introduces a phase function which is described by equation (1):

φ(x,y)=a*(x²+y²) (1)

where x and y specify the Cartesian co-ordinates in the plane perpendicular to the optical axis OA (extending in the z-direction) and where a=2.177946*10⁻³ mm applies for the microstructuring 117 in accordance with this embodiment. The diffractive optical structure formed by the microstructuring 117 has a grating constant which rises quadratically in relation to the spacing from the optical axis and which attains about 1550 L/mm at the edge of the structure.

In the example shown in FIG. 2 the liquid layer formed by the immersion liquid 114 is comparatively thick in order to produce a sufficiently great spacing for the diffractive optical structure formed by the microstructuring 117 from the image plane IP.

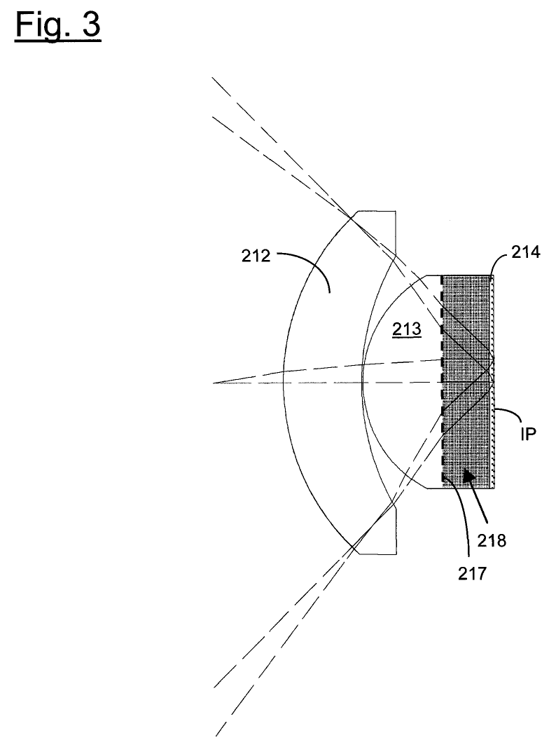

Referring to FIG. 3 the last optical element at the image plane side is formed from a first subelement and a second subelement insofar as here a plane plate 218 is arranged at the light exit side of a planoconvex lens 213 (e.g., wrung or cemented thereto), in which respect here a microstructuring 217 can be in the form of a CGH (=“computer generated hologram”) on the light exit surface of the planoconvex lens 213 and is thus arranged at the interface between the planoconvex lens 213 and the plane plate 218. The plane plate 218 is produced from a more highly refractive material (in comparison with quartz) and in the present embodiment comprises lutetium aluminum garnet (Lu₃Al₅O₁₂, LUAG) with a refractive index of n=2.14 at λ=193 nm. Further suitable more highly refracting materials include MgAl₂O₄ (spinel), Y₃Al₅O₁₂ (YAG), NaCl, ZrO₂:0.12 Y₂O₃, Al₂O₃ and Y₂O₃. The immersion liquid is identified by 214 in FIG. 3 and is between the plane plate 218 and the image plane IP.

The design data of the arrangement shown in FIG. 3 are set forth in Table 2 in a similar manner to Table 1, with radii and thicknesses again being specified in millimeters (mm).

TABLE 2

| Surface | Radius | Thickness | Diameter | Material | n |
|---|---|---|---|---|---|
| 1 | 145.310 | 49.965 | 210.39 | SiO₂ | 1.56 |
| 2 | 156.337 | 1.000 | 159.63 | | |
| 3 | 75.917 | 50.395 | 129.47 | SiO₂ | 1.56 |
| 4 | flat | 30.000 | 96.27 | LUAG | 2.14 |
| (diffractive | | | | | |
| optical | | | | | |
| structure) | | | | | |
| 5 | flat | 3.000 | 39.70 | Dekalin | 1.65 |
| Image field | flat | | 28.0 | | |

The diffractive optical structure formed by the microstructuring 217 introduces a phase function which is described by foregoing equation (1), in this case a=2.906262*10⁻³ mm applying. The diffractive optical structure formed by the microstructuring 217 has a grating constant of about 1450 L/mm. In the example of FIG. 3 the plane plate 218 is comparatively thick in order to produce a sufficiently great spacing for the diffractive optical structure formed by the microstructuring 217 from the image plane IP.

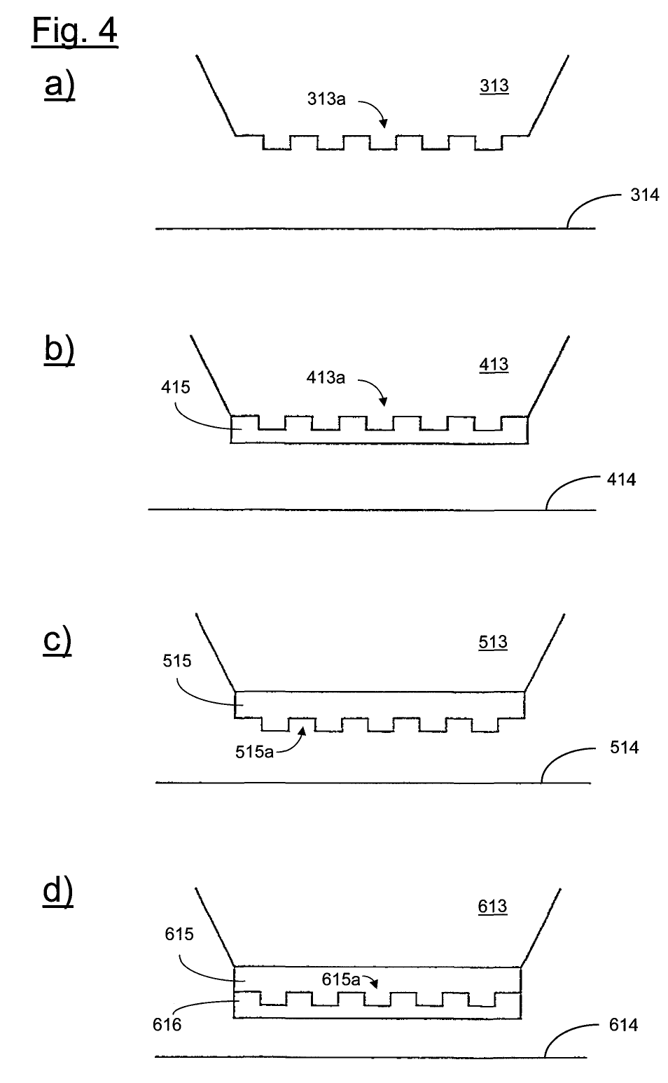

FIG. 4 shows diagrammatic views to describe the implementation of a microstructuring.

In this respect, in each case a last optical element at the image plane side is only diagrammatically illustrated above the image plane (accommodating the light-sensitive layer), in which respect for the sake of greater simplicity of the drawing the immersion liquid disposed therebetween has not been shown here.

In FIG. 4a a microstructuring 313a is provided in the light exit surface of the last optical element 313 at the image plane side (so that this case corresponds to the embodiment of FIG. 1 and FIG. 2).

In FIG. 4b a microstructuring 413a is provided as in FIG. 4a in the last optical element 413 at the image plane side, in which case however this microstructuring 413a is here covered by a layer 415. The material of the layer 415 here has, at the working wavelength, a higher refractive index than the material of the last optical element 413 at the image plane side (which for example is made from quartz or calcium fluoride). That layer 415 on the one hand provides protection for the microstructuring 413a while on the other hand it also avoids the surface roughness which is introduced by the microstructuring 413a occurring at the interface in relation to the immersion liquid so that improved wetting of that interface with immersion liquid is also achieved.

In FIG. 4c the material from which the last optical element 513 at the image plane side is made is initially not microstructured but has a flat surface which is then coated with a layer 515, a microstructuring 515a at the light exit side being produced in that layer 515. The layer 515 again can have at the working wavelength a higher refractive index than the material of the last optical element 513 at the image plane side (for example of quartz or calcium fluoride).

Referring to FIG. 4d a layer 615 which, similarly to FIG. 4c, is produced on the last optical element 613 at the image plane side and provided with a microstructuring 615a can also be coated in turn with a layer 616 (which for example has substantially the same refractive index as the immersion liquid). The layer 616 once again on the one hand provides a protective action for the microstructuring 615a while on the other hand avoiding the surface roughness introduced by that microstructuring occurring at the interface in relation to the immersion liquid, thereby achieving improved wetting of that interface with immersion liquid.

Although the disclosure has been described by embodiments numerous variations and alternative embodiments will be apparent to the man skilled in the art, for example by combination and/or exchange of features of individual embodiments. Accordingly it will be appreciated by the man skilled in the art that such variations and alternative embodiments are also embraced by the present disclosure and the scope of the disclosure is limited only in the sense of the accompanying claims and equivalents thereof.

1. A projection objective configured to project an object in an object plane to an image plane, the projection objective comprising:
an optical element, the optical element being the optical element of the projection objective that is closest to the image plane of the projection objective, the optical element having a light entrance surface and a light exit surface; and
a liquid between the light exit surface of the optical element and the image plane of the projection objective, the liquid having a refractive index of at least 1.5 at a working wavelength of the projection objective,
wherein there is an interface between the light entrance surface of the optical element and the liquid, the interface has a microstructuring, and the projection objective is configured to be used in a microlithographic projection exposure apparatus.

2. The projection objective as set forth in claim 1, wherein at the working wavelength of the projection objective the liquid has a refractive index of at least 1.6.

3. The projection objective as set forth in claim 1, wherein the microstructuring is provided at the light exit surface of the optical element.

4. The projection objective as set forth in claim 1, further comprising a layer on the light exit side of the optical element.

5. The projection objective as set forth in claim 4, wherein at the working wavelength of the projection objective the layer has a refractive index that is greater than a refractive index of a material from which the optical element is formed.

6. The projection objective as set forth in claim 4, wherein the layer covers the microstructuring.

7. The projection objective as set forth in claim 4, wherein the microstructuring is provided at a light exit surface of the layer.

8. The projection objective as set forth in claim 7, further comprising a further layer covering the microstructuring.

9. The projection objective as set forth in claim 8, wherein the further layer has a refractive index which is substantially the same as the refractive index of the liquid.

10. The projection objective as set forth in claim 1, wherein the optical element comprises first and second subelements, and the microstructuring is at an interface between the first and second subelements.

11. The projection objective as set forth in claim 10, wherein the first and second subelements are seamlessly joined together.

12. The projection objective as set forth in claim 10, wherein the first subelement is a planoconvex lens.

13. The projection objective as set forth in claim 12, wherein the second subelement is a planoparallel plate.

14. The projection objective as set forth in claim 10, wherein the second subelement comprises a material which at the working wavelength of the projection objective has a refractive index greater than that of SiO₂.

15. The projection objective as set forth in claim 10, wherein the second subelement comprises a material which at the working wavelength of the projection objective has a refractive index of at least 1.7.

16. The projection objective as set forth in claim 10, wherein the second subelement comprises a material selected from the group consisting of lutetium aluminum garnet (Lu₃Al₅O₁₂), spinel (MgAl₂O₄), yttrium aluminum garnet (Y₃Al₅O₁₂), NaCl, ZrO₂:0.12 Y₂O₃, Al₂O₃ and Y₂O₃.

17. The projection objective as set forth in claim 10, wherein the first subelement comprises SiO₂.

18. The projection objective as set forth in claim 17, wherein the microstructuring is a diffractive grating structure with a grating constant in the range of between 200 L/mm and 3000 L/mm.

19. The projection objective as set forth in claim 1, wherein the microstructuring is a blazed diffractive optical structure.

20. The projection objective as set forth in claim 1, wherein the microstructuring is a quantized diffractive optical structure.

21. The projection objective as set forth in claim 1, wherein the projection objective has a numerical aperture of at least 1.2.

22. The projection objective as set forth in claim 1, wherein the working wavelength of the projection objective is less than 250 nm.

23. An apparatus, comprising:
an illumination system; and
a projection objective as set forth in claim 1,
wherein the apparatus is a microlithographic projection exposure apparatus.

24. A process, comprising:
using a microlithographic projection exposure apparatus of claim to produce microstructured components, wherein the microlithographic projection exposure apparatus comprises:
an illumination system; and
a projection objective as set forth in claim 1.

25. The method of claim 24, wherein the method comprises using the projection objective to project at least a part of a mask onto a region of a layer of light sensitive material.
